(19) United States
(12) Patent Application Publication
(10) Pub. No.: US 2009/0070209 A1
(43) Pub. Date: Mar. 12, 2009

(54) System and method for providing advertising reflexive to user input

(75) Inventor: Baron RK Von Wolfsheild, La Tuna Canyon, CA (US)

Correspondence Address: GATES & COOPER LLP;HOWARD HUGHES CENTER, 6701 CENTER DRIVE WEST, SUITE 1050, LOS ANGELES, CA, 90045, US

(73) Assignee: Qtask

(21) Appl. No.: 11/900,059

(22) Filed: Sep. 10, 2007

(51) Int. Cl. G06Q 30/00; G06F 17/30

(52) U.S. Cl. 705/14

(57) ABSTRACT

A method and apparatus for presenting reflexive advertising to a user is disclosed. User input is monitored and from time to time, transmitted to a remote server that compares the user input to a set of keywords. This comparison is used to identify suitable advertising to be presented to the user.

### BACKGROUND OF THE INVENTION

1. Field of the Invention

The present invention relates to systems and methods for providing directed advertising, and in particular to a system and method for reflexively providing directed advertising to a computing device for presentation to a user.

2. Description of the Related Art

Advertising has long been used to underwrite the presentation of media without cost to consumers. It has also been known that the advertising presented in such media is more effective if the content of the advertising closely matches the interests of the viewer or group of viewers. Consequently, in traditional media outlets such as radio and television, merchants attempt to schedule advertisements so that they are viewed by the target demographic. This involves scheduling the advertisement for the appropriate time of day when the target demographic is most likely to be watching, and scheduling the advertisement to run in conjunction with a media program that the target demographic is likely to be interested in. For example, an advertiser selling surfboards would be more interested in scheduling an advertisement to run with an evening media program about outdoor activity, and less interested in scheduling the advertisement to run with a daytime soap opera. In such traditional media outlets, directed advertising has been limited to proper selection of the appropriate media program and time of day.

Beyond association with the media program and the time of day that the advertisement is broadcast, traditional media outlets offered little in the way of directed advertising capability. However, because of the nature of the medium, newer media providers such as YAHOO and GOOGLE currently provide directed advertising in an Internet context. Two general models have been used.

The first model involves the compilation of personal information regarding the user by examination of the user's clickstream (which websites the user visits and the content of those websites). This information is stored either in the user's computer or a remote computer, and retrieved by use of cookies stored in the user's computer. The information is used to gather user preference information, so that an advertisement relevant to the user's interests can be provided. One of the problems with this model is that spyware programs can delete or quarantine (disable) cookies, thus reducing their effectiveness.

The second model does not use the user's clickstream, nor does it require the use of cookies. In this model, the Internet portal scans Internet websites offline and generates a database of information relating the address (or uniform resource locator (URL)) of each website to its content. The content can be expressed in key words found in the website itself or in key words generated from a human or an algorithm examining the website. When the address of that website is invoked (due to a web search or other activity), the Internet portal uses the database of information to look up the key words or content associated with the website at the address, and uses those key words to identify directed advertising for the user.

The Applicant has recognized a number of problems associated with the foregoing methods of directed advertising. Many of these methods respond only to user queries to search engines and the like. While such queries provide useful input in implementing directed advertising, they typically do not provide enough keywords to provide enough information to sufficiently focus the directed advertising because the number of keywords is small. Also, since such advertisements are presented in a context where the user is looking for something else (the subject of the query), often, users disregard the directed advertising and focus on the query results instead. Such search engines also decide which advertisements to present based upon the sum total of the words in the query, all presented at one time. That limits the number of advertisements that can be presented, and may also present directed advertising that is too narrowly focused. Hence, the Applicant has recognized that there is a need for a system and method for providing directed advertising that is capable of monitoring the entry of textual user input in a non-querical input field and periodically transmitting those entries to a remote server, and for receiving advertisements selected using the transmitted entries for presentation on the user's computer.

Other directed advertising systems and methods have been devised, including those summarized below, each of which is hereby incorporated by reference herein:

U.S. Pat. No. 7,089,194, entitled “Method and apparatus for providing reduced cost online service and adaptive targeting of advertisements” discloses a system that examines data transmitted downstream to the user, and uses that examined data to determine which ads to send to the user. This system uses the data transmitted from the server to the client to identify advertising, and hence, does not monitor the entry of textual user input into a non-querical input field.

U.S. Pat. No. 7,028,072, entitled “Method and apparatus for dynamically constructing customized advertisements” discloses a system that examines a user's clickstream to identify banner advertisements sent to the user. This system does not monitor the entry of textual user input into a non-querical input field.

U.S. Pat. No. 7,007,074, entitled “Targeted advertisements using time-dependent key search terms” discloses an advertisement generation system that presents a time-dependent advertisement to a user based upon a search term of a search query during a period of time via a communication network. This system is based on querical inputs and does not monitor the user's input.

U.S. Pat. No. 6,785,659, entitled “Agent-based technique for implementing browser-initiated user-transparent interstitial web advertising in a client computer” discloses a technique for implementing in a networked client-server environment, e.g., the Internet, network-distributed advertising in which advertisements are downloaded, from an advertising server to a browser executing at a client computer, in a manner transparent to a user situated at the browser, and subsequently displayed, by that browser on an interstitial basis, in response to a clickstream generated by the user to move from one web page to the next. This system utilizes the user's clickstream to identify suitable advertising.

U.S. Pat. No. 6,654,725, entitled “System and method for providing customized advertising on the World Wide Web” discloses a system and method for “clickthrough” based customized advertisement selection and delivery on the World Wide Web (WWW) upon the Internet. This system also utilizes the user's clickstream to identify suitable advertising.

U.S. Pat. No. 6,144,944, entitled “Computer system for efficiently selecting and providing information” discloses a system for selecting and providing advertising information in response to a request from a web page server. The request includes request information such as demographic information, page sponsor information, and keyword sponsor information that allows the advertisement server to select an appropriate advertisement. The system, however, does not monitor user input into a non-querical input field and periodically transmit portions of this monitored input for purposes of selecting advertisements to present within the browser.

U.S. Pat. No. 6,141,010, entitled “Computer interface method and apparatus with targeted advertising” discloses providing an automatically upgradeable software application that includes targeted advertising based upon demographics and user interaction with the computer. However, this system provides advertisements based on user selection of a key or a particular function of the underlying application. No provision is made to use simple, non-querical textual user input to determine which advertising material is to be transmitted to the user's computer.

U.S. Pat. No. 6,044,376, entitled “Content stream analysis” discloses a system and method for using content stream analysis to profile a user. The disclosed system likewise does not disclose the use of simple, non-querical textual user input to determine which advertising material is to be transmitted to the user's computer.

U.S. Pat. No. 6,009,410, entitled “Method and system for presenting customized advertising to a user on the World Wide Web” discloses a customized advertising repository server. When the user accesses his or her customized ad repository through the browser, a composite advertising page is dynamically configured for that particular user based on that user's previously provided user profile.

U.S. Publication No. 20040059632, entitled “Method and system for providing an advertisement based on an URL and/or a search keyword entered by a user” discloses a method and apparatus for providing an advertisement to a user over the Internet, based on a URL and/or a search keyword that the user entered. This system relies on querical inputs and does not monitor the user input at all.

U.S. Publication No. 20020052925, entitled “Method and apparatus for information delivery on the Internet” discloses a system and method for delivering targeted multimedia or video advertisements over the Internet. A software application and a browser are executed separately on a user's computer. The application periodically accesses the server over the Internet to download and locally store targeted advertisements during user idle time. When the user activity meets predefined criteria, e.g., user's mouse clicking action on a hotlink causing a web page transition, the application picks up matching content based on the text label associated with the hotlink, to present the locally stored advertisements. However, this system does not provide the user targeted advertisements based on monitored textual user input.

U.S. Publication No. 20020010757, entitled “Method and apparatus for replacement of on-line advertisements” discloses an Internet advertisement replacement system, wherein original advertising content is replaced by new advertising content based on a user profile. Likewise, this system relies on user profiles and not monitored non-querical user inputs.

The document “Fuzzy Matching of User Profiles for a Banner Engine,” ICCSA 2004, LNCS 3045, 443-442 by Milani, Morici and Niewiadomski discloses the use of fuzzy matching of user profiles for a Banner engine. It does not, however, disclose monitoring an entry of a non-querical free form textual user input in an input field of a browser and transmitting that entry to a remote server for use in providing advertisements to a client computer.

The document “Unintrusive Customization Techniques for Web Advertising”, CNISDN, 1999 v31, 1259-1272 discloses supplying advertisements based on keywords supplied by a user to a search engine. This system is analogous to querical input-based search engines described above.

The document “Ubiquitous Advertising on the WWW: Merging Advertisement on the Browser”, CNISDN, 1996 v28, 1493-1499 discloses the use of an advertising agent between advertisers and users. However, this system also does not provide user-targeted advertisements based on monitored textual user input.

The document “The Privacy Practices of Web Browser Extensions”, Communications of the ACM, February 2001, 45 discloses privacy concerns with regard to directed advertising, including the examination of URLs requested by users. It does not, however, disclose the monitoring and periodic transmission of portions of non-querical user inputs.

The document “Qumana brings easy ad insertion to TypePad users” (http://www.htmlprimer.com/news/news/061207QAdds.html) discloses a system which enables a blogger to identify key words that are used to direct advertising to users who are visiting the blog. This system is a tool designed for bloggers, and does not monitor non-querical user inputs.

The document “Will Gmail read your mail?” PC Magazine Online, 13 Apr. 2004 discloses a system that would potentially inspect users' hosted web-based e-mails to gather information to present targeted advertisements. However, the input provided into the e-mail messages is not continuously monitored, transmitted and acted on in real time. Rather, the information is not transmitted to the web portal until the user transmits the e-mail. Consequently, any advertisements related to the user input cannot be provided at the same time that the textual input from the user is being provided.

### SUMMARY OF THE INVENTION

To address the requirements described above, the present invention discloses a method of reflexively providing directed advertising from a server to a client computer for presentation to a user. In one embodiment, the method comprises the steps of monitoring an entry of a non-querical free form textual user input in an input field of a browser executing on the client computer, transmitting portions of the monitored entry of the non-querical textual user input from the browser executing on the client computer to a server remote from the client computer, comparing the non-querical textual user input with a plurality of keywords, identifying an advertisement based at least in part on the comparison between the non-querical textual user input and the plurality of keywords, and receiving the advertisement in the client computer for presentation in the browser. In another embodiment, the present invention may be described as an apparatus for reflexively providing directed advertising from a server to a client computer for presentation to a user, which comprises a client computer, implementing a monitoring module for monitoring an entry of a non-querical free form textual user input in an input field of a browser executing on the client computer, the client computer further comprising a means for transmitting portions of the monitored entry of the non-querical textual user input from the browser executing on the client computer to a server remote from the client computer, a remote server, for comparing the non-querical textual user input with a plurality of keywords, and a database for identifying an advertisement based at least in part on the comparison between the non-querical textual user input and the plurality of keywords, wherein the client computer further receives the advertisement for presentation in the browser.

In another embodiment, the invention may be described by a method of reflexively providing directed advertising from a server to a client computer for presentation to a user that comprises the steps of receiving a mapping between a plurality of keywords and a plurality of advertisements from a server remote from the client computer, monitoring a non-querical textual user input in a browser executing on the client computer, comparing the monitored non-querical textual user input with a plurality of keywords, identifying an advertisement based at least in part on the comparison between the non-querical textual user input and the plurality of keywords, and receiving the advertisement in the client computer for presentation in the browser.

The foregoing system and method allows the user to be presented with multiple advertisements and advertisements that reflexively change with the user's thoughts (reflected by each portion of the textual input) at the time of the textual input, instead of the advertisements based on the sum cumulative total of his/her thoughts at the time the user commands the data to be transmitted.

### BRIEF DESCRIPTION OF THE DRAWINGS

Referring now to the drawings in which like reference numbers represent corresponding parts throughout:

FIG. 1 is a diagram illustrating an exemplary computer system that can be used to implement elements of the present invention;

FIG. 2 is a functional block diagram illustrating one embodiment of a system for providing reflexive advertising;

FIG. 3 is a diagram presenting a simplified example of a webpage on a display using a browser;

FIG. 4 is a diagram illustrating an exemplary webpage that may result when the user clicks on one of the hotlinks;

FIG. 5 is a diagram illustrating exemplary method steps that can be used to provide reflexive advertising;

FIG. 6 is a diagram illustrating an exemplary webpage that results when the user enters the word “beer” in the input field;

FIG. 7 is a diagram illustrating an exemplary webpage with an advertisement presented to the user upon entry of the term “bread” in the input field following the entry of “beer” in the input field;

FIG. 8 is a diagram illustrating a further exemplary webpage resulting when the user enters “apples” into the input field following the entry of “beer” and “bread” in the input field;

FIG. 9 is a diagram illustrating an alternative embodiment of the system for providing reflexive advertising to the user in which predefined keywords are preloaded in the client computer and the comparison of user entries and keywords takes place in the client computer;

FIG. 10 is a diagram illustrating an alternative embodiment of the system for providing reflexive advertising to the user, in which the advertisements themselves are provided from an advertising server;

FIG. 11 is a diagram illustrating an alternative embodiment of the system for providing reflexive advertising to the user, in which the remote server provides the client computer with keyword/URL pairings; and

FIG. 12 is a diagram illustrating an alternative of the system for providing reflexive advertising to the user, in which the remote server provides the client computer with keyword pairings and the remote server and the advertising server do not communicate directly with one another.

### DETAILED DESCRIPTION OF THE PREFERRED EMBODIMENTS

In the following description, reference is made to the accompanying drawings which form a part hereof, and in which are shown, by way of illustration, several embodiments of the present invention. It is understood that other embodiments may be utilized and structural changes may be made without departing from the scope of the present invention.

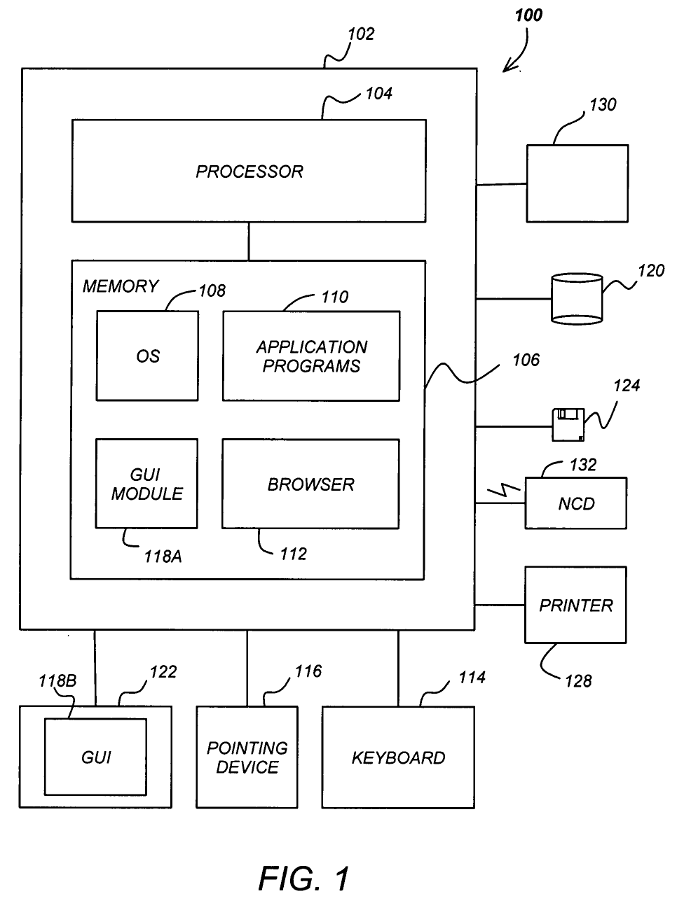

FIG. 1 illustrates an exemplary computing device 100 that could be used to implement elements of the present invention. In the illustrated embodiment, the computing device comprises a computer 102 having a processor 104 and a memory, such as random access memory (RAM) 106. The computer 102 is operatively coupled to a display 122, which presents images such as windows to the user on a graphical user interface 118B. The computer 102 may be coupled to other devices, such as a text input device such as a keyboard 114, a mouse device 116, a printer, etc. The computer 102 may also be communicatively coupled to an external network such as the Internet via network connection device 132. Communications between the computer 102 and the external network may be wired or wireless.

Of course, those skilled in the art will recognize that any combination of the above components, or any number of different components, peripherals, and other devices, may be used with the computer 102.

Generally, the computer 102 operates under control of an operating system 108 stored in the memory 106, and interfaces with the user to accept inputs and commands and to present results through a graphical user interface (GUI) module 118A. Although the GUI module 118A is depicted as a separate module, the instructions performing the GUI functions can be resident or distributed in the operating system 108, the application program 110, or implemented with special purpose memory and processors. The computer 102 may also implement an Internet browser 112 (such as INTERNET EXPLORER available from the MICROSOFT CORPORATION or FIREFOX, available from MOZILLA) and a plurality of other application program(s) 110. The browser 112 and application program(s) 110 access and manipulate data stored in the memory 106 of the computer 102 using the relationships and logic of the browser 112 and application program(s) 110, respectively.

In one embodiment, instructions implementing the operating system 108, the computer program 110, and the browser 112 are tangibly embodied in a computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of instructions which, when read and executed by the computer 102, causes the computer 102 to perform the steps necessary to implement and/or use the present invention. Computer program 110 and/or operating instructions may also be tangibly embodied in memory 106 and/or data communications devices, thereby making a computer program product or article of manufacture according to the invention. As such, the terms “article of manufacture,” “program storage device,” and “computer program product” as used herein are intended to encompass a computer program accessible from any computer readable device or media.

Those skilled in the art will recognize many modifications may be made to this configuration without departing from the scope of the present invention. For example, those skilled in the art will recognize that any combination of the above components, or any number of different components, peripherals, and other devices, may be used with the present invention.

Although the embodiment of the computing device 100 shown in FIG. 1 comprises a computer 102, the computing device 100, may be implemented in other ways as well. For example, the computing device 100 may comprise a personal data assistant (PDA), a web-enabled cellphone, or any other device having Internet access and processing capability.

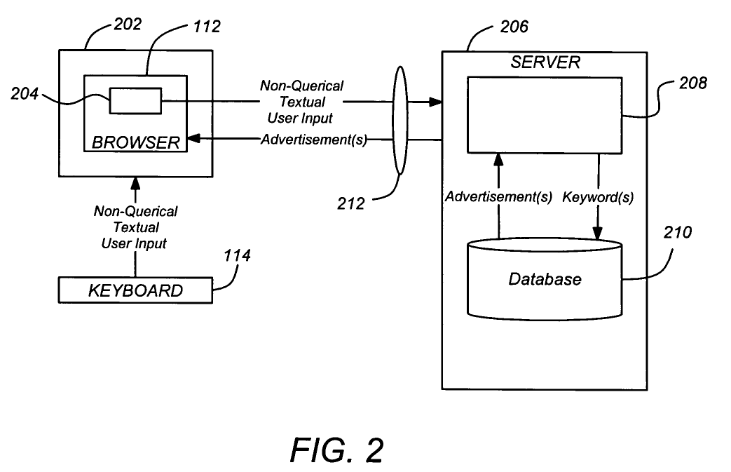

FIG. 2 is a functional block diagram illustrating one embodiment of a system for providing reflexive advertising. The client computer 202 implements a browser 112. The browser 112 can be used to access and display the content of webpages by reference to a uniform resource locator (URL), and presents the webpages on the display 122 using the GUI 118B.

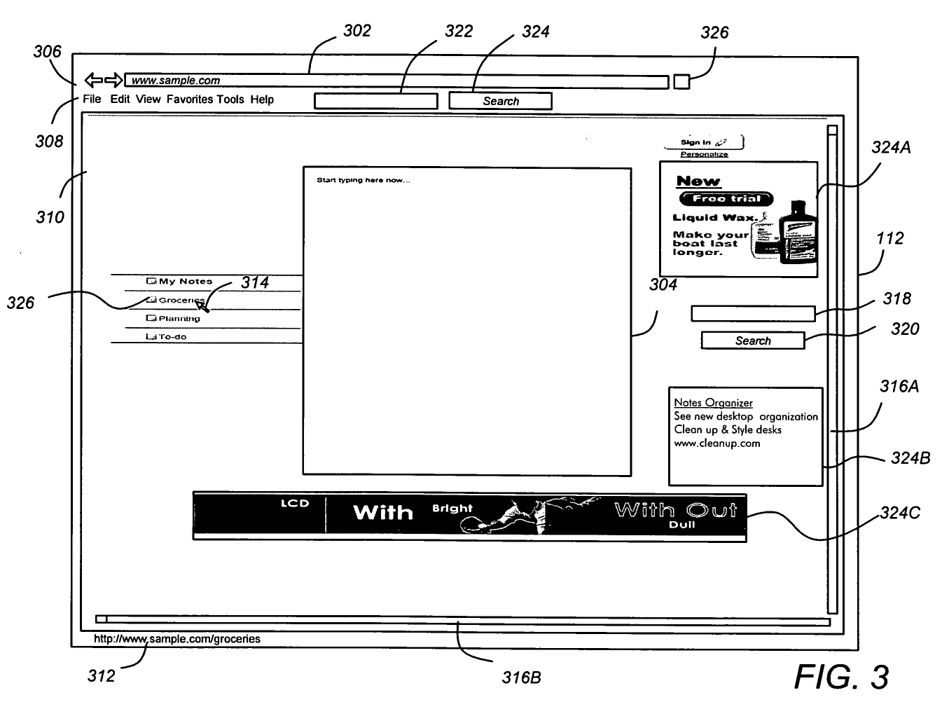

FIG. 3 is a diagram presenting a simplified presentation of a webpage 310 on the display 122 using browser 112. The browser 112 includes a URL input field 302, a “go” button 326, which causes the browser 112 to transmit the data entered into the URL input field 302 to the user's Internet service provider (ISP), to retrieve the webpage at the entered URL, navigation buttons 306, drop-down menu 308, scroll bars 316A, 316B, and a mouse pointer 314 that can be moved about using the pointing device 116.

In the illustrated embodiment, the browser 112 also includes an annunciator 312 that is activated when the cursor rolls over active window elements that select a webpage with a different URL. For example, in FIG. 3, the keyword “Groceries” is used to describe a webpage having the address “www.sample.com/groceries”, and when the mouse pointer 314 is rolled over the “Groceries” hotlink 326 in the webpage 310, that web address is presented by the annunciator 312.

The webpage 310 may also include a query input field 318. The user can perform an Internet search by entering a query (e.g. querical words, phrases or sentences) into the input field 318 and selecting the search button 320. After the search button 320 is depressed, the query is transmitted via the Internet to a remote search engine where it is parsed and used to perform a search for appropriate webpages having content described by the query. The query input field may also be implemented in the browser 112 itself, as shown by the second query input field 322 and second search button 324. This feature can be implemented using one or more browser 112 plug-ins.

The webpage 310 also includes one or more advertisement portions 324A and 324B (hereinafter alternatively referred to as advertisement portion(s) 324). This portion 324 of the webpage 310 is used to present advertisements to the user, and will be discussed in further detail below. In the embodiment shown in FIG. 3, advertisement portion 324A provides an illustration (and optionally, a clickable weblink) for a boat wax product, while advertisement portion 324B provides weblinks to POST-IT related merchandise, and advertisement portion 324C provides an illustration and optional clickable weblink to another vendor or service provider.

The webpage 310 also includes an input field 304 that the user can use to enter non-querical free form textual user input. This input field 304 and the data entered into it is distinguished from the querical input field 318 and the text entered therein in that the data entered is not a query that the user actively transmits to a known search engine with the intent and expectation of receiving a query result, but rather, non-querical input that is intended to be used in connection with providing data input to the function offered by the webpage 310. In the illustrated embodiment, the function offered by the webpage 310 is to offer a web-based electronic “POST-IT” so that the user can access anything typed on the “POST-IT” anywhere the user has access to the Internet.

The input field 304 and the text entered into it is also distinguished from the URL input field 302 and the text entered into it in that it is free form (it is not subject to a protocol) and in that it is not entered for purposes of navigating webpages or performing a search. It is noted that some browsers 112 perform search queries when free form input is provided to the URL input field 302. For example, if one types in the phrase “times square” or “www.timesquare” into the URL input field 302, the browser will recognize the lack of proper protocol in the phrase or the fact that no such website exists for the entered URL and instead, perform a search using terms parsed from the user's input into the URL input field 302. However, none of the foregoing takes place until the user selects the “go” button 326.

The browser 112 may also scan information typed into the URL input field 302 and compare the information input to previously input URLs, and return a series of URLs that match the current input. This can be used to provide a way for the user to enter a long, complex URL that the user has entered before.

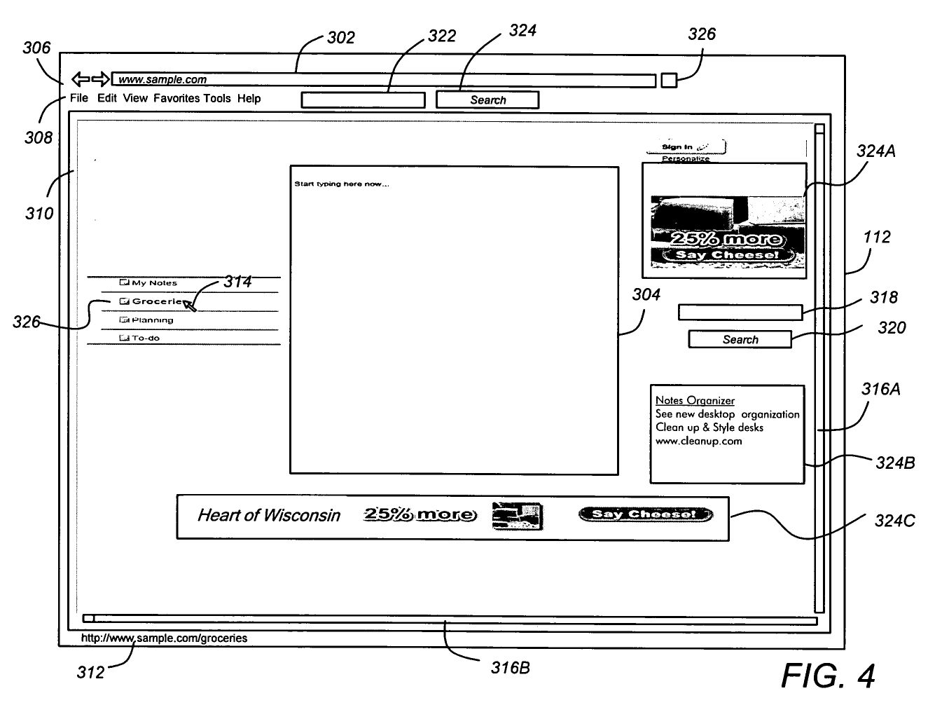

FIG. 4 is a diagram illustrating an exemplary webpage 310 that may result when the user clicks on the “Groceries” hotlink 326. Note that the advertisement in the first advertising portion 324A and the third advertising portion 324C has changed to present an advertisement that is related to the user's selection of the “groceries” hotlink 326, in the illustrated case, an advertisement for cheese.

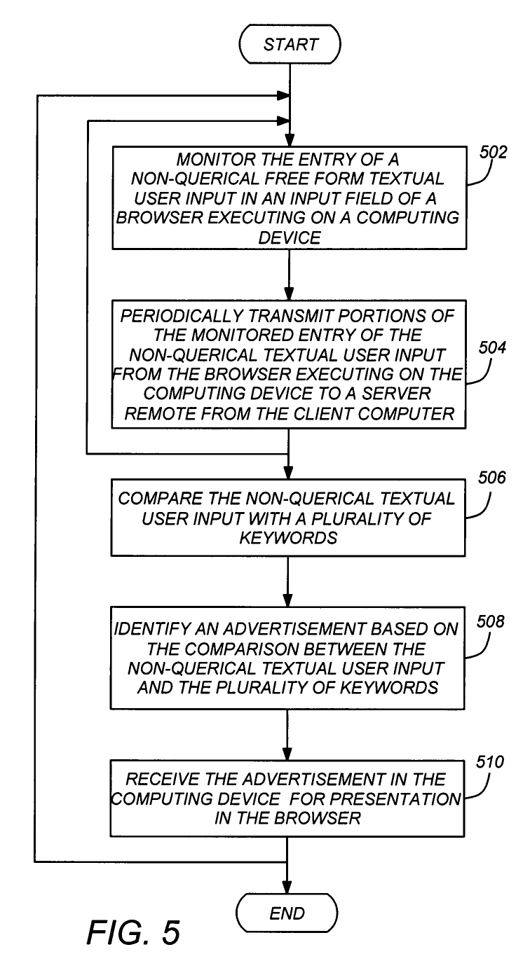

FIG. 5 is a diagram illustrating exemplary method steps that can be used to provide reflexive advertising. In this example, the user enters non-querical free-form text into the input field 304 and that text is used to provide reflexive directed advertising to the user.

As shown in block 502, a non-querical free-form textual user input entered into an input field 304 of a browser 112 is monitored. In this context, “textual” includes one or more alphanumeric characters and/or symbols. In one embodiment, the input field 304 is monitored to identify user input concurrent with the acceptance of the user input itself. In the embodiment shown in FIG. 2, this monitoring operation is performed by a monitoring software module 204 such as a script, that is downloaded with the webpage 310 and running in the browser 112. In other embodiments, the monitoring software module 204 can be implemented in the operating system 108 or as a browser 112 plug-in, or in the source code of the browser 112 itself.

Preferably, the monitoring operation described above is performed continuously, so that the monitoring software detects characters as they are entered into the input field 304 with essentially no delay. “Continuous monitoring” is therefore distinguished from “non-continuous” monitoring, where it is expected that the user will input a plurality of characters, words, or perhaps an entire document before the user input is detected or used to identify appropriate advertisements.

Of course, true “continuous monitoring” is only possible in analog systems, as digital systems inherently require a non-continuous sampling operation. However, in the context of the invention herein described, “continuous monitoring” includes sampling the user input at a rate high enough so that the time it takes to detect the user input is insignificant compared to the time it takes the user to enter it. For example, if a typical user types in a letter about every 0.1 second when the user is actively typing, “continuously monitoring” the user input may include sampling the user input every 0.05 or seconds. Another example of “continuous monitoring” is to monitor any input event using an input event driver. Such input events could include, for example, a key event. In this case, the user's input is monitored with every press and/or release of a key on the keyboard. Another such input could include a click of a mouse button either inside or outside of the non-query input field 304.

The monitored entry of the non-querical textual user input from the browser 112 is transmitted to a server 206 remote from the client computer 202, as shown in block 504. This information may be transmitted via the Internet 212 as shown in FIG. 2. Although this information may be transmitted when the user selects a “Send” button or similar control on the browser, this information may be transmitted as each character, word, or phrase is entered, or soon thereafter. In this case, the information is transmitted without any further input from the user (e.g. the user need not select an “enter” or “transmit” button).

For purpose of illustration, consider the example where input field 304 represents a grocery list, and the user has three items to add to the grocery list: (1) beer, (2) bread, and (3) apples. In this case, the user entry comprises three words, “beer”, “bread”, and “apples”, each perhaps separated by an appropriate delimiter such as a carriage return, space, comma, or other punctuation mark or nothing at all.

Importantly, these terms (“beer”, “bread”, and “apples”) are provided as a data input (the items in a grocery list) to the underlying function of the browser (in this case, providing an electronic grocery list). The terms are non-querical because they do not represent a query or other input to a search engine . . . the list is a plurality of data items that the user types into what amounts to an electronic list. The terms are also entered free-form because they need not comply with any particular protocol.

Using keyboard 114, the user enters the first portion of the entry . . . the term “beer.” The monitoring software module 204 monitors the entry of these characters and transmits the information to server 206. In one embodiment, this monitoring operation proceeds concurrently with the acceptance of the user data in real time or near real time (e.g. the monitoring operation and acceptance of the data proceed concurrently), as shown in block 502. In another embodiment, the monitoring operation proceeds periodically, or using queues from the input data itself. For example, the monitoring operation may be queued by a pause in the user input, or a space, colon, semicolon, or other delimiter.

The monitored user entry is transmitted from the browser 112 to a server 206 remote from the client computer, as shown in block 504. In one embodiment, the monitoring software module 204 transmits the entered characters as they are entered by the user. In other words, if the entered word is “beer,” the letter “b” is transmitted to the server 206 immediately or at least near real time. In another embodiment, the monitoring software module transmits the entered characters occasionally (e.g. after the occurrence of a specified event), such as a pause in the user input. In other words, if the user enters the term “beer” and pauses, the information is transmitted to the server 206 after a suitable amount of time (for example, 2-5 seconds) has elapsed since the last user input. Other embodiments are possible wherein the user entry is transmitted when a delimiter (e.g. a space, colon, semi-colon, or a comma) is entered. In yet another embodiment, the monitoring software module 204 transmits the entered characters periodically (e.g. after a regular period of time has elapsed since the last transmission), aperiodically (after an irregular period of time has elapsed since the last transmission). The monitoring software module 206 may also transmit the information when prompted by the server 206 (e.g. a “send information now” command), or at the time of a defined processing event (e.g. occasionally).

The non-querical textual user input is then compared with a plurality of keywords that are related to one or more advertisements, as shown in block 506. In the embodiment shown in FIG. 2, this is accomplished by an advertising identifier module 208 implemented in the remote server 206.

In block 508, one or more advertisements are identified based upon the comparison between the non-querical user input and the keywords. In the embodiment shown in FIG. 2, this is accomplished by the advertising identifier module 208 transmitting keywords identified by the comparison of block 506 to a database 210 either resident with or remote from the server 206 and receiving advertisements or addressing information for advertisements of interest, based on the keywords. In its simplest form, the database 210 may be a simple list. In one embodiment, the advertisement is selected according to a frequency in which one or more of the plurality of keywords appears in the non-querical textual user input. For example, if the user input includes the phrase “Car Repair: Need a new transmission” the terms “car,” “repair,” and “transmission” are all used to select the advertisement to be provided to the user. The terms “car” and “transmission” can be identified as related because cars have transmissions. Further, the term “repair” can be used to modify and further narrow the scope of advertisements suitable for presentation to the user to those involving transmission repair.

Finally, as shown in block 510, the identified advertisements are received in the client computer 202 and presented in the browser 112.

Note that in the embodiment illustrated in FIG. 2, the advertisement was transmitted from the remote server 206 to the client computer 202. However, this need not be the case. Instead, the remote server may transmit an address (e.g. URL) to the client computer 202, and software within the client computer 202 receives that URL and retrieves the advertisement from the website at the specified URL.

In the foregoing discussion, “monitoring” of the user entry is to be distinguished from a user entering data into the input field 304 followed by transmission command (whether by selecting a control such as a “send” or “transmit” button or equivalent). Further, it is important to note that the provision of the advertisements is “reflexive” in the sense that it occurs automatically and non-volitionally in response to a user input not normally associated with the transmission of data or the reception of advertisements.

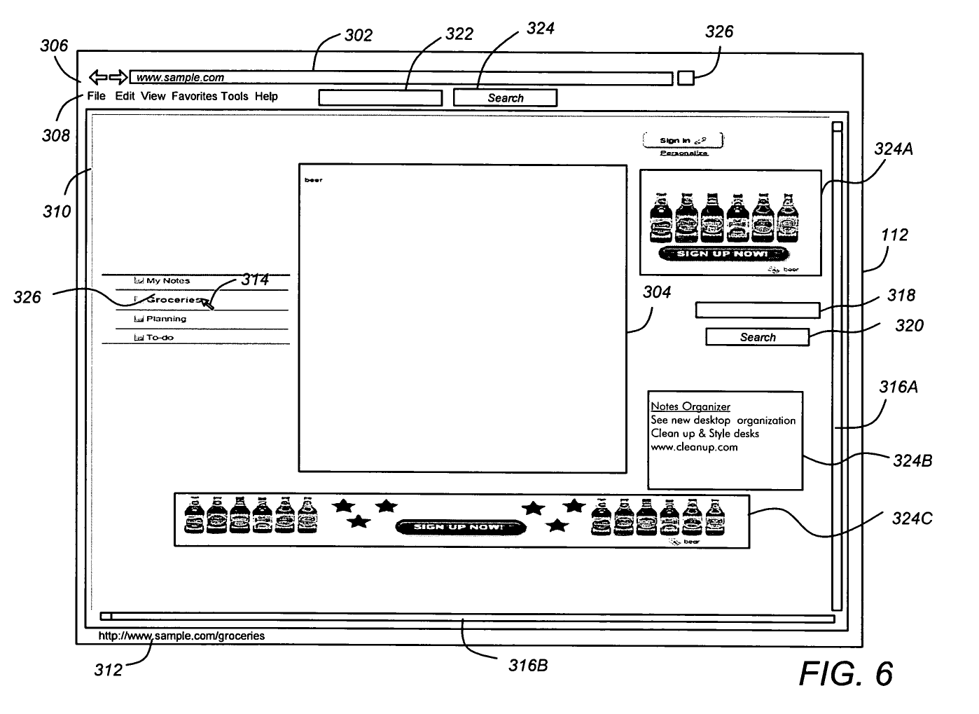

FIG. 6 is a diagram illustrating an exemplary webpage 310 that may result when the user enters the word “beer” into the monitored input field 304 of the browser 112. Note that the term “beer” appears in the input field 304 and that the advertisement presented in the first advertising portion 324A and the second advertising portion 324C have changed to reflect the entered word “beer.” Importantly, this was accomplished without the user selecting any button in the browser 112 or elsewhere to transmit the data to the remote server 206. Instead, the user merely entered the word “beer” and either immediately or after a short pause, the advertising presented in the browser 112 was altered to reflect the user input.

Although the embodiment shown in FIG. 6 illustrates the change of two advertising portions (e.g. 324A and 324C) to reflect the monitored user input, other embodiments may change all of the advertising portions 324A-324C to reflect the user input or may change only one of the advertising portions. In still another embodiment, numerous input fields are provided in the browser, with adjacent advertising portions 324, and only the advertising portion nearest the input field where user data is entered is changed. In yet another embodiment, the data provided by the user into the input field is parsed by the remote server, and a plurality of advertisements are presented to the user based on the user input, with each advertisement keyed to one of the user's entries or a group of user entries.

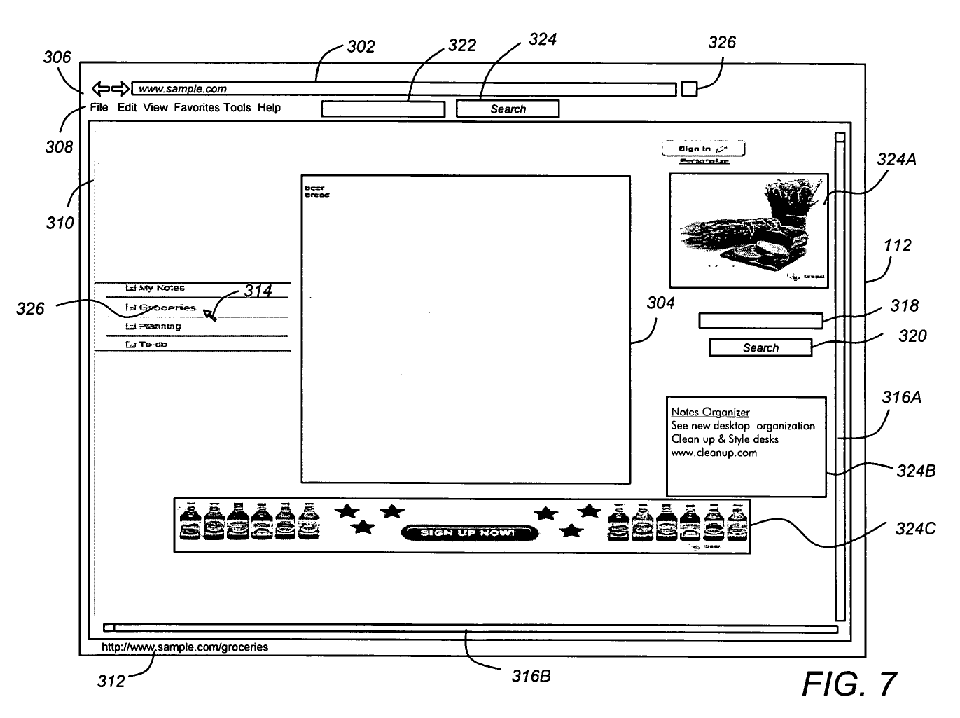

As the user enters other portions of the user entry into the input field 304, the process described above repeats. For example, if the user then enters the term “bread” in the input field 304, the user input is monitored as shown in block 502, transmitted to the remote server as shown in block 504, compared with the plurality of keywords, as shown in block 506, and an advertisement based on the comparison between the user input and the keywords is identified, received, and presented to the user. FIG. 7, for example, illustrates an advertisement that may be presented to the user in the browser 112 upon entry of the term “bread” into the input field 304. Note that the term “bread” is present in the input field, and advertising portion 324A now includes an ad for bread and related products. Note also that in this embodiment, the advertisement for beer remains in the advertising portion 324C.

In one embodiment, the aggregated non-querical textual user input entered into the input field 304 is compared to the plurality of keywords and that comparison forms the basis for the identification of advertisements to be presented to the user. In other words, if a user enters the word “beer” followed by the word “bread” in the input field 304 both keywords are used to determine which advertising is to be presented to the user. The result may be a single advertisement sufficiently related to both beer and bread, an advertisement related to beer and a second advertisement related to bread or any other combination of advertisements selected based upon both “beer” and “bread”.

In another embodiment, the incremental non-querical textual user input entered into the input field 304 is compared to the plurality of keywords, and that comparison forms the basis for the identification of advertisements to be presented to the user. This can be accomplished by comparing the first non-querical textual user input (in the cited example, the word “beer”) with the further non-querical textual user input (“bread”), and the comparison is used to identify incremental non-querical textual user input (a transition between “beer” and “bread”). Alternatively, this can be accomplished by comparing the first non-querical textual user input (“beer”) with a combination of the first and further non-querical textual user input (“beer bread”) to identify incremental non-querical textual user input (“bread”). The incremental non-querical user input can then be compared to the plurality of keywords, and a second advertisement can be identified based on this comparison and sent to the client computer 202.

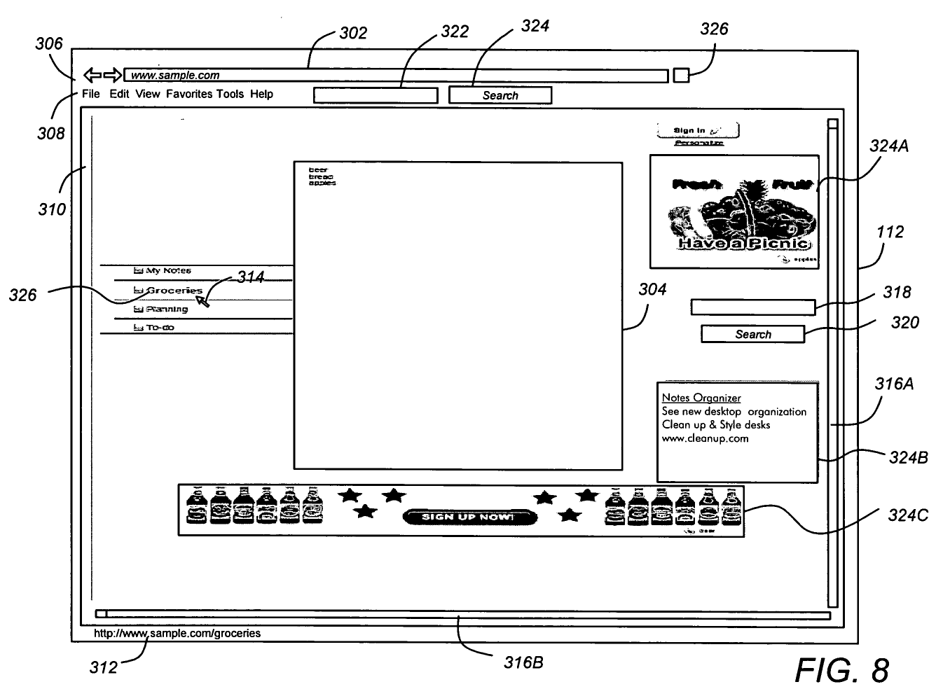

FIG. 8 is a diagram illustrating a further exemplary embodiment in which the user has entered the word “apples” in the input field 304. Note that the advertisement presented in the first advertising portion 324A has now changed to present an advertisement related to the incremental entry “apples” (e.g. an advertisement for fruit). In this embodiment, the advertisements presented in other advertising portions 324B and 324C have not changed, however, as described above, the advertisements presented in these portions 324 may change to reflect the current or incremental terms entered into the input field 304.

In addition to transmitting monitored data entered into the input field 304, the client computer 202 may optionally transmit information identifying the user. This information can be used by the remote server 206 to select advertisements that are personalized to the user (in addition to the text entered into the input field 304). The identifying information may be stored as a cookie in the client computer 202. In order that more personalized advertisements may be selected, the remote server may aggregate information regarding the user as well. “Information identifying the user” may include the user's name or similar identification, or simply a unique number that distinguishes one user from other users, but which has no connection whatsoever with the name and true identity of the user. This identifying information may also permit group membership and group identification as well.

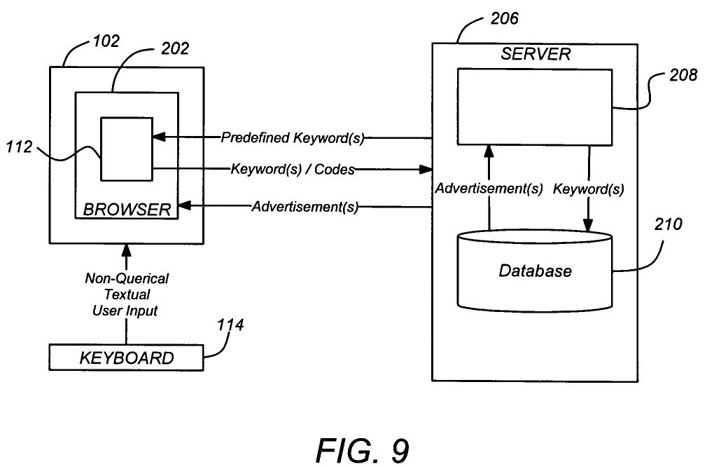

FIG. 9-FIG. 12 are diagrams illustrating alternative implementations. In the embodiment illustrated in FIG. 2, a monitoring software module 204 simply monitors user input into the input field 304 and transmits the user input (albeit, in some embodiments, after some delay or aggregation) to the remote server 206. In this embodiment, the remote server 206 is responsible for the analysis of the user input and the comparison to keywords in a keyword database to determine the appropriate advertisements to transmit to the client computer 202.

One difficulty with embodiment described above is that all of the user input is transmitted to the remote server 206. Although this information would have been transmitted to the remote server 206 (to some remote entity) in any case in order to take advantage of the functionality offered by the webpage presenting the input field 304 (in this case, a shopping list), the transmission of such data, particularly when it is monitored and not transmitted by an affirmative act of the user (e.g. a depression of a “save” or a “send” button), can raise privacy concerns. Such concerns can be ameliorated by the embodiment illustrated in FIG. 9.

In this embodiment, the remote server (or another entity) 206 transmits keywords to the client computer 202, where the keywords are stored. Updated or altered keywords may be sent on a periodic or as-needed basis for similar storage. When the user enters data into the input field 304, this input data is compared to the downloaded keywords internally by the client computer 202 itself. When the words entered into the input field 304 match one or more of the keywords stored in the client computer 202, the client computer 202 transmits those keywords and only those keywords to the remote server 206. Thus, in this embodiment, although the data entered into the input field 304 is continually monitored, not every word entered therein results in a transmission to the remote server 206. Instead, a transmission results only when the data entered into the input field 304 matches one or more of the previously downloaded keywords. This increases the privacy of the user's entries into the input field 304, as only keywords are transmitted.

To increase the security of the transmission and decrease the bandwidth required for transmission, the keywords themselves need not be transmitted from the client computer 202 to the remote server 206. Instead, the transmissions may be coded either using asymmetric keys (e.g. a private/public key pair using RSA techniques) or an asymmetric key (e.g. a shared secret). Or, the transmissions may be coded using a simple code (e.g. 01=beer, 02=vegetables, 03=canned pears). The codes may be derived from a mapping transmitted from the remote server 206 to the client computer 202. For example, the remote server 206 may transmit one or more messages to the client computer 202 indicating the following keyword/code pairs “beer/a2; bread/s3; apples/f4.” Then, after the user enters the terms “beer,” “bread,” and “apples” into the input field 304, the client computer 202 may transmit the codes “a2” “s3”, and “f4” to the remote server 206 instead of the input values. Keyword/code pairs may be global (e.g. the same for all client computers) or individual (e.g. different for each client computer 202). Embodiments using individually differing keyword/code pairs permit additional security, as the information transmitted from the client computer 202 to the remote server 206 will have no usefulness without the keyword/code mapping.

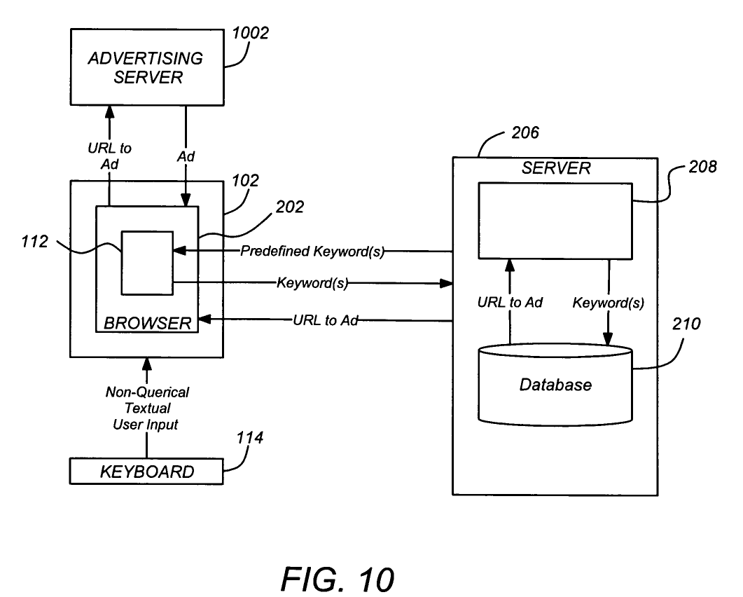

FIG. 10 is a diagram presenting another embodiment in which the advertisements themselves are provided from an advertising server 1002 instead of the remote server (or the database 210). In this embodiment, in response to keywords received from the remote server 206, the database responds with URLs to the appropriate advertisements instead of the advertisements themselves. The URLs are then transmitted from the remote server 206 to the client computer 202, and the URLs are used to download the appropriate advertisements from the advertisement server 1002. This embodiment has the advantage that the advertising server 1002 may be managed by the entity presenting the advertisements, allowing the advertisements to be rapidly changed as the advertiser may desire, and allowing the advertiser to collect its own statistics regarding the number of times the advertisement is requested.

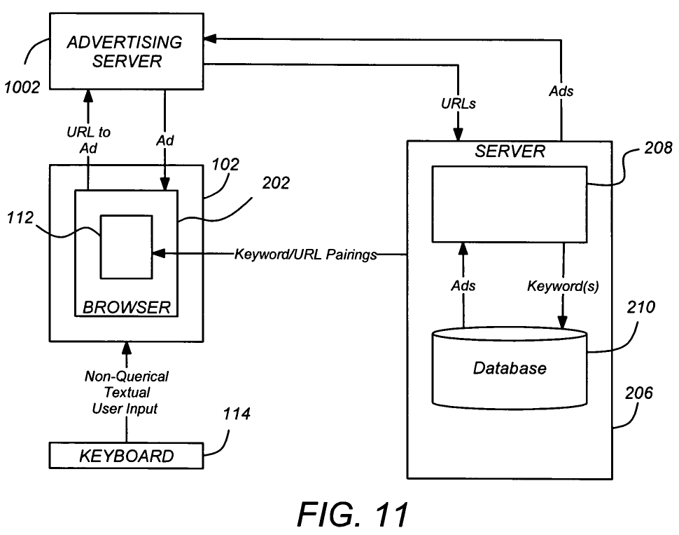

FIG. 11 is a diagram illustrating another embodiment of the invention. In this embodiment, remote server 206 supplies the client computer 202 with keyword/URL pairings (e.g. a list or database relating keywords to the URL for an advertisement sufficiently related to the keyword). The client computer 202 then compares user entries into the input field 304 with the keywords/URL list, and retrieves the appropriate advertisement using the URL associated with the keyword. For example, the remote server 206 transmits a series of keyword/URL pairings (although there may be several URLs related to a keyword or several keywords related to a URL). The keyword/URL pairings may be as follows:

| | |
|---|---|
| beer | www.advertismentserver.com/user520/beer/morning |
| bread | www.advertisementserver.com/user520/bread/morning |
| apples | www.calamityjane.com/user520/apples/morning |

The first portion of the URL indicates the address of the advertising server 1002 that the advertisement will be obtained from. The second portion (e.g. “user520”) optionally identifies the user for which the advertisement is related. The third portion (e.g. bread, beer, and apples) identifies the subject of the advertising (which may, but need not identify the keyword). Finally, the optional fourth portion identifies the time of day that the person has entered the data into the input field 304. This feature allows advertisements to be customized not only to the user and what the user enters into the input field, but also as to the time of day (in recognition that some products are more appropriately advertised at a particular time of day).

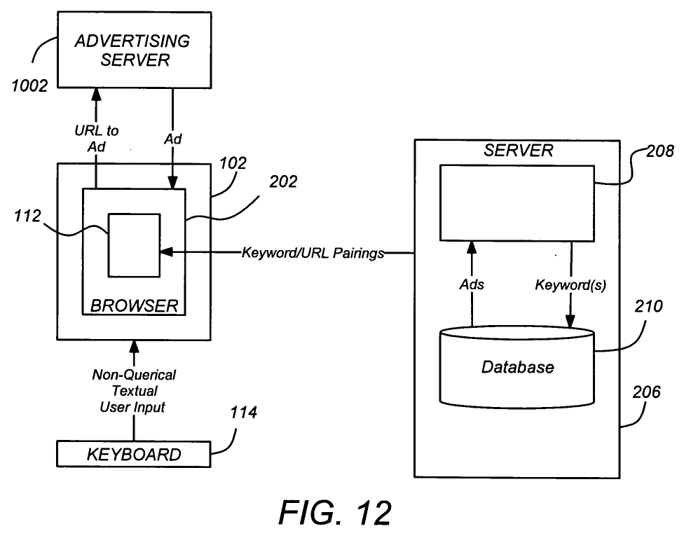

FIG. 12 is a diagram illustrating another embodiment of the invention. This embodiment is similar to the embodiment illustrated in FIG. 11, however, in this embodiment, the advertising server 1002 and the remote server 206 are separate entities that do not communicate directly with one another. This is in contrast to the embodiment shown in FIG. 11, in which the remote server 206 provides the advertisements to the advertising server 1002 and the advertising server 1002 responds with the URL to each of the provided advertisements.

### CONCLUSION

This concludes the description of the preferred embodiments of the present invention. The foregoing description of the preferred embodiments of the invention has been presented for the purposes of illustration and description. It is not intended to be exhaustive or to limit the invention to the precise form disclosed. Many modifications and variations are possible in light of the above teaching. For example, the browser 112 discussed above can be any means for displaying Internet content and able to accept user input to the user, and the Internet 212 can be any network for transmitting information from one computing system to another.

It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method of reflexively providing directed advertising from a server to a computing device for presentation to a user, comprising the steps of:
continuously monitoring an entry of a non-querical free form textual user input in an input field of a browser executing on the computing device;
transmitting portions of the monitored entry of the non-querical textual user input from the browser executing on the computing device to a server remote from the computing device;
comparing the non-querical textual user input with a plurality of keywords;
identifying an advertisement based at least in part on the comparison between the non-querical textual user input and the plurality of keywords; and
receiving the advertisement in the computing device for presentation in the browser.

2. The method of claim 1, wherein the non-querical textual user input is transmitted from the computing device to the server after a pause in the entry of the non-querical user input.

3. The method of claim 1, wherein the non-querical textual user input is transmitted from the computing device to the server upon a user command.

4. The method of claim 1, further comprising the step of:
transmitting the advertisement from the server to the computing device.

5. The method of claim 1, wherein:
the method further comprises the steps of transmitting a uniform resource locator of an advertisement from the server to the computing device; and
the step of receiving the advertisement in the computing device for presentation in the browser comprises the step of retrieving the advertisement from a server identified by the uniform resource locator.

6. The method of claim 1, further comprising the steps of:
continuously monitoring further non-querical textual user input in the browser executing on the computing device;
transmitting the further non-querical textual user input from the computing device to a server remote from the computing device;
comparing the non-querical textual user input with a combination of the non-querical textual user input and the further non-querical textual user input to identify incremental non-querical textual user input;
comparing the incremental non-querical textual user input with the plurality of keywords;
identifying a second advertisement based on the comparison between the incremental non-querical textual user input and the plurality of keywords; and
receiving the second advertisement to the computing device for presentation in the browser.

7. The method of claim 1, wherein the advertisement is selected according to a frequency in which one or more of the plurality of key words appears in the non-querical textual user input.

8. The method of claim 1, wherein the advertisement is presented in the browser without refreshing the browser.

9. The method of claim 1, wherein the textual user input is converted into a coded input at the computing device before transmission and decoded at the server before comparing the non-querical textual user input with the plurality of keywords.

10. The method of claim 9, wherein the coded input is derived from a mapping transmitted from the server to the client.

11. The method of claim 1, wherein the monitoring and transmitting steps are performed in near real time.

12. The method of claim 1, wherein the portions of the monitored entry of the non-querical textual user input are transmitted without a user-initiated transmit command.

13. An apparatus for reflexively providing directed advertising from a server to a computing device for presentation to a user, comprising:
means for continuously monitoring an entry of a non-querical free form textual user input in an input field of a browser executing on the computing device;
means for transmitting portions of the monitored entry of the non-querical textual user input from the browser executing on the computing device to a server remote from the computing device;
means for comparing the non-querical textual user input with a plurality of keywords;
means for identifying an advertisement based at least in part on the comparison between the non-querical textual user input and the plurality of keywords; and
means for receiving the advertisement in the computing device for presentation in the browser.

14. The apparatus of claim 13, wherein the non-querical textual user input is transmitted from the computing device to the server after a pause in the entry of the non-querical user input.

15. The apparatus of claim 13, wherein the non-querical textual user input is transmitted from the computing device to the server upon a user command.

16. The apparatus of claim 13, further comprising:
means for transmitting the advertisement from the server to the computing device.

17. The apparatus of claim 13, wherein:
the apparatus further comprises means for transmitting a uniform resource locator of an advertisement from the server to the computing device; and
means for receiving the advertisement in the computing device for presentation in the browser comprises the step of retrieving the advertisement from a server identified by the uniform resource locator.

18. The apparatus of claim 13, further comprising:
means for continuously monitoring further non-querical textual user input in the browser executing on the computing device;
means for transmitting the further non-querical textual user input from the computing device to a server remote from the computing device;
means for comparing the non-querical textual user input with a combination of the non-querical textual user input and the further non-querical textual user input to identify incremental non-querical textual user input;
means for comparing the incremental non-querical textual user input with the plurality of keywords;
means for identifying a second advertisement based on the comparison between the incremental non-querical textual user input and the plurality of keywords; and
means for receiving the second advertisement to the computing device for presentation in the browser.

19. The apparatus of claim 13, wherein the advertisement is selected according to a frequency in which that one or more of the plurality of key words appears in the non-querical textual user input.

20. The apparatus of claim 13, wherein the advertisement is presented in the browser without refreshing the browser.

21. The apparatus of claim 13, wherein the textual user input is converted into a coded input at the computing device before transmission and decoded at the server before comparing the non-querical textual user input with the plurality of keywords.

22. The apparatus of claim 21, wherein the coded input is derived from a mapping transmitted from the server to the client.

23. The apparatus of claim 13, wherein the monitoring and transmitting steps are performed in near real time.

24. The apparatus of claim 13, wherein the portions of the monitored entry of the non-querical textual user input are transmitted without a user-initiated transmit command.

25. An apparatus for reflexively providing directed advertising from a server to a computing device for presentation to a user, comprising:
a computing device, implementing a monitoring module for continuously monitoring an entry of a non-querical free form textual user input in an input field of a browser executing on the computing device, the computing device further comprising a means for transmitting portions of the monitored entry of the non-querical textual user input from the browser executing on the computing device to a server remote from the computing device;
a remote server, for comparing the non-querical textual user input with a plurality of keywords; and
a database for identifying an advertisement based at least in part on the comparison between the non-querical textual user input and the plurality of keywords;
wherein the computing device further receives the advertisement for presentation in the browser.

26. The apparatus of claim 25, wherein:
the means for continuously monitoring monitors further non-querical textual user input in the browser executing on the computing device;
the computing device transmits the further non-querical textual user input from the computing device to a server remote from the computing device;
the remote server compares the non-querical textual user input with a combination of the non-querical textual user input and the further non-querical textual user input to identify incremental non-querical textual user input and compares the incremental non-querical textual user input with the plurality of keywords;
the database identifies a second advertisement based on the comparison between the incremental non-querical textual user input and the plurality of keywords; and
the computing device further receives the second advertisement to the computing device for presentation in the browser.

27. A method of reflexively providing directed advertising from a server to a computing device for presentation to a user, comprising the steps of:
receiving a mapping between a plurality of keywords and a plurality of advertisements from a server remote from the computing device;
continuously monitoring a non-querical textual user input in a browser executing on the computing device;
comparing the monitored non-querical textual user input with a plurality of keywords;
identifying an advertisement based at least in part on the comparison between the non-querical textual user input and the plurality of keywords; and
receiving the advertisement in the computing device for presentation in the browser.

28. The method of claim 27, wherein the non-querical textual user input is compared to the plurality of keywords after a pause in the entry of the non-querical user input.

29. The method of claim 27, wherein the non-querical textual user input is compared to the plurality of keywords upon a user command.

30. The method of claim 27, further comprising the step of:
transmitting the advertisement from the server to the computing device.

31. The method of claim 30, further comprising the steps of:
continuously monitoring further non-querical textual user input in the browser executing on the computing device;
comparing the non-querical textual user input with a combination of the non-querical textual user input and the further non-querical textual user input to identify incremental non-querical textual user input;
comparing the incremental non-querical textual user input with the plurality of keywords;
identifying a second advertisement based on the comparison between the incremental non-querical textual user input and the plurality of keywords; and
receiving the second advertisement to the computing device for presentation in the browser.

32. An apparatus for reflexively providing directed advertising from a server to a computing device for presentation to a user, comprising:
means for receiving a mapping between a plurality of keywords and a plurality of advertisements from a server remote from the computing device;
means for continuously monitoring a non-querical textual user input in a browser executing on the computing device;
means for comparing the monitored the non-querical textual user input with a plurality of keywords;
means for identifying an advertisement based at least in part on the comparison between the non-querical textual user input and the plurality of keywords; and
means for receiving the advertisement in the computing device for presentation in the browser.

33. The apparatus of claim 32, wherein the non-querical textual user input is compared to the plurality of keywords after a pause in the entry of the non-querical user input.

34. The apparatus of claim 32, wherein the non-querical textual user input is compared to the plurality of keywords upon a user command.

35. The apparatus of claim 32, further comprising:
means for transmitting the advertisement from the server to the computing device.

36. The apparatus of claim 32, further comprising:
means for continuously monitoring further non-querical textual user input in the browser executing on the computing device;
means for comparing the non-querical textual user input with a combination of the non-querical textual user input and the further non-querical textual user input to identify incremental non-querical textual user input;
means for comparing the incremental non-querical textual user input with the plurality of keywords;
means for identifying a second advertisement based on the comparison between the incremental non-querical textual user input and the plurality of keywords; and
means for receiving the second advertisement to the computing device for presentation in the browser.
